(19) United States
(12) Patent Application Publication
(10) Pub. No.: US 2006/0171296 A1
(43) Pub. Date: Aug. 3, 2006

(54) Apparatus and method for selecting serving sector in a mobile communication system

(75) Inventors: Anil Agiwal, Bangalore (IN); Sudhir Kumar Baghel, Bangalore (IN)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/322,650

(22) Filed: Jan. 3, 2006

(30) Foreign Application Priority Data
Dec. 31, 2004 (IN) 1483/CHE/2004

(51) Int. Cl. H04B 7/00

(52) U.S. Cl. 370/209; 370/331; 370/310; 455/161.3

(57) ABSTRACT

An apparatus and method is provided for determining a serving sector using a signal received from a base station. A received signal strength measurer measures a strength of a pilot signal received from the serving sector and a strength of a pilot signal received from a sector in an active set. A controller then calculates a difference between the strength of the pilot signal received from the serving sector and the strength of the pilot signal received from the sector in the active set, updates selection parameters by comparing the calculated difference with a predetermined threshold, and selects a best serving sector from the active sectors in the active set using the updated selection parameters and comparative parameters. A memory can be implemented to store the parameters.

### CROSS-REFERENCE TO RELATED APPLICATIONS

This application claims the benefit under 35 U.S.C. §119(a) of Indian Application No. 1483/CHE/2004 entitled “Apparatus and Method for Selecting Serving Sector in a Mobile Communication System” filed in the Indian Intellectual Property Office on Dec. 31, 2004, the entire disclosure of which is hereby incorporated by reference.

### BACKGROUND OF THE INVENTION

1. Field of the Invention

The present invention relates generally to an apparatus and method for selecting a sector in a wireless communication system. In particular, the present invention relates to an apparatus and method for selecting a serving sector in a mobile communication system.

2. Description of the Related Art

In general, a mobile communication system is a typical wireless communication system. The mobile communication system has been developed to allow users to perform communication regardless of their locations. The mobile communication system has evolved from an early voice-oriented system into an advanced system that provides a data service. Among Code Division Multiple Access (CDMA) communication systems supporting the data service, a 1xEV-DO system and a 1xEV-DV system, both called “High Data Rate (HDR) system,” are now in commercialization phases.

The CDMA mobile communication system distinguishes users with limited orthogonal code resources, providing voice service and/or data service to the users. In order to provide data service to more users at a higher data rate using the limited resources, the CDMA mobile communication system uses a sectorization technique developed for dividing each cell covering its associated base station (BS) into a plurality of sectors.

Therefore, the conventional CDMA communication system has cells each formed of a plurality of BSs, and each BS is divided again into a plurality of sectors. Thus, a terminal located in coverage of a particular BS performs communication with a network mainly through a sector where it is located. In this case, an access terminal (AT) belongs to one or more cells or sectors in performing communication. In the CDMA communication system, when a user performs communication with two or more cells or sectors, traffic to be provided to the user is routed to each sector. As a result, an AT receives traffic from all active cells or sectors to which it belongs.

FIG. 1 is a diagram illustrating an arrangement of BSs and a location of an AT in a conventional cellular CDMA communication system. With reference to FIG. 1; a description will now be made of the exemplary arrangement of the BSs and location of the AT in a conventional cellular CDMA communication system.

In FIG. 1, a first BS (BS1) 110, a second BS (BS2) 120, and a third BS (BS3) 130 are illustrated. Each of the BSs 110, 120 and 130 has 3 sectors. Specifically, the first BS 110 has sectors X1, Y1 and Z1; the second BS 120 has sectors X2, Y2 and Z2; and the third BS 130 has sectors X3, Y3 and Z3. As illustrated in FIG. 1, an AT 101 is located in a boundary of the first BS 110. Also, the AT 101 belongs to the sector X1 and is located in a boundary between the sectors X1 and Y1.

If the AT 101 is located as illustrated in FIG. 1, it can be said that the AT 101 is located in a handover region. Therefore, in the conventional mobile communication system, when soft handover is performed, the same signals are received from at least two more sectors. The same data is routed to different sectors, and finally delivered the AT 101.

When transmitting data to one AT, the 1xEV-DV, 1xEV-DO, or HDSPA system, which are CDMA data communication systems supporting a high data rate, routes the data to only one sector in order to maximize output of downlink data traffic. That is, the system transmits the data to only one AT. Therefore, the AT should continuously monitor all active sectors, select the best serving sector among the active sectors, and inform a network of the selected best serving sector. Then, the network transmits data to the best serving sector informed by the AT. Such a method for selecting the best serving sector is called “site selection transmission diversity.”

According to a recent approach to use a method for selecting the best serving sector, an AT selects a serving sector having the highest-strength downlink signal among all active sectors, and informs a network of the selected serving sector through a feedback channel.

A description will now be made of a process of selecting a serving sector by an AT in a conventional mobile communication system.

In a first step, the AT measures strength of a downlink signal from each of all active sectors, and monitors the measured signal strengths.

In a second step, the AT compares the strengths of downlink signals from all the active sectors, and selects a sector having the highest-strength downlink signal as a serving sector.

In a third step, the AT informs a network of the selected serving sector through a feedback channel.

This process is continuously repeated to monitor strengths of downlink signals from all active sectors.

In this method, the AT can perform fast sector switching because it continuously monitors downlink signal strengths for the active sectors every time and informs the network of the monitoring result. Therefore, whenever switching of a serving sector occurs, data to be transmitted to the AT must be transmitted to a data queue of the corresponding sector. As a result, the AT cannot receive the data until the data queue is prepared. The fast switching of the serving sector causes considerable network overhead or outage of data to the AT. In addition, when a serving sector is selected based on pilot strength at a particular time, the pilot strength may be measured higher than expected due to wrong signal strength measurements or surges. In this case, the effective strength of a signal received from the selected serving sector decreases. That is, if the serving sector is switched fast without taking the foregoing problems into consideration, communication quality may deteriorate due to outage of data and abnormal selection of the serving sector.

Accordingly, a need exists for a system and method for efficiently and effectively selecting a serving sector to be used.

### SUMMARY OF THE INVENTION

It is, therefore, an object of the present invention to substantially solve the above and other problems, and provide an apparatus and method for selecting a correct serving sector.

It is another object of the present invention to provide an apparatus and method for preventing unnecessary network switching occurring due to an error in selecting a serving sector.

It is another object of the present invention to provide an apparatus and method for selecting a serving sector such that data can be stably transmitted.

It is yet another object of the present invention to provide an apparatus and method for preventing frequent switching of a serving sector.

It is still another object of the present invention to provide an apparatus and method for increasing throughput of a network.

According to one aspect of the present invention, an apparatus is provided for determining a serving sector using a signal received from a base station. The apparatus comprises a received signal strength measurer for measuring a strength of a pilot signal received from the serving sector and a strength of a pilot signal received from a sector in an active set, a controller for calculating a difference between the strength of the pilot signal received from the serving sector and the strength of the pilot signal received from the sector in the active set, updating selection parameters by comparing the calculated difference with a predetermined threshold, and selecting a best serving sector from the active sectors in the active set using the updated selection parameters and comparative parameters, and a memory for storing the parameters.

According to another aspect of the present invention, a method is provided for determining a serving sector using a signal received from a base station. The method comprises the steps of measuring strength of a pilot signal received from a sector in an active set, calculating a difference between the measured strength of the signal received from the sector in the active set and strength of a signal received from the serving sector, comparing the calculated difference with a predetermined threshold and updating selection parameters according to the comparison result, and selecting a best serving sector from active sectors in the active set using the updated selection parameters and comparative parameters.

### BRIEF DESCRIPTION OF THE DRAWINGS

The above and other objects, features and advantages of the present invention will become more apparent from the following detailed description when taken in conjunction with the accompanying drawings, in which:

FIG. 1 is a diagram illustrating an exemplary arrangement of BSs and an exemplary location of an AT in a conventional cellular CDMA communication system;

FIG. 2 is a flowchart illustrating a process of selecting a best serving sector by an AT in a CDMA communication system according to an embodiment of the present invention;

FIG. 3 is a flowchart illustrating a process of updating a selection parameter according to an embodiment of the present invention;

FIG. 4 is a flowchart illustrating a process of selecting a best serving sector by an AT according to an embodiment of the present invention; and

FIG. 5 is a block diagram illustrating an exemplary internal structure of an AT according to an embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

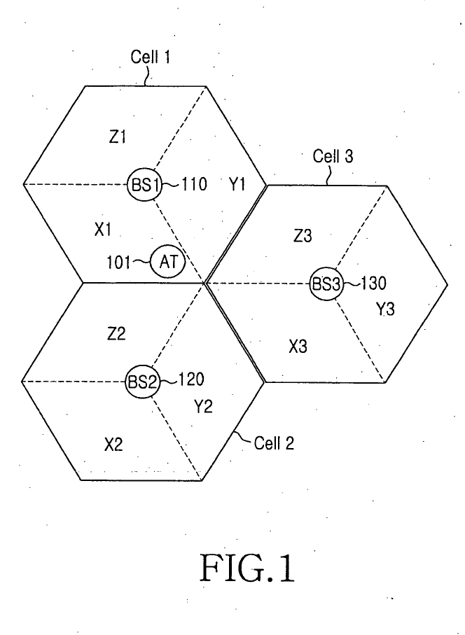

An exemplary environment, to which the present invention is applicable, will be described prior to a description of various aspects and detailed contents of embodiments of the present invention. The conventional high-data rate CDMA system is illustrated in FIG. 1. The exemplary CDMA system shown in FIG. 1, as described above, includes a total of 3 cells comprising cell #1, cell #2 and cell #3, but is not limited thereto. Each cell comprises 3 sectors, and a description thereof has been given above. It is assumed herein for example, that the AT 101 communicates with 3 active sectors X1, Y1 and Z3, and the sector X1 is a current serving sector. In this case, data traffic to be transmitted to the AT 101 is routed from a BS1 to the sector X1 and then transmitted from the sector X1 to the AT 101.

Therefore, the AT 101 continuously monitors strengths of downlink signals from the active sectors X1, Y1 and Z3. If the downlink signal strength for the sector Z3 is assumed for example, to be the highest at a particular time, the AT 101 will immediately select the sector Z3 and inform a network of the selected sector Z3. As a result, the data traffic is routed to the sector Z3 of a third BS 130, and then transmitted from the sector Z3 to the AT 101.

Thereafter, if the sector X1 has the highest downlink signal strength at a certain time, the AT 101 will select the sector X1 as a new serving sector. At the next time, the sector Z3 will have the highest downlink signal strength. After several minutes, if the sector X1 has the highest downlink signal strength, fast switching may occur between two or more sectors. Each time the switching of a serving sector occurs, data to be transmitted to the AT 101 must be transmitted to a data queue of the corresponding sector. As a result, undesirable fast switching occurs.

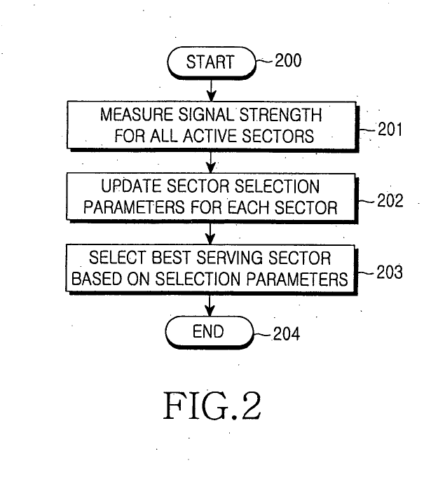

FIG. 2 is a flowchart illustrating a process of selecting a best serving sector by an AT in a CDMA communication system according to an embodiment of the present invention. With reference to FIG. 2, a detailed description will now be made of a process of selecting a best serving sector by an AT in a CDMA communication system according to an embodiment of the present invention.

The flowchart shown in FIG. 2 according to an embodiment of the present invention includes a process of selecting a best serving sector to implement site selection transmission diversity for an AT. This process can be implemented in an AT by hardware, software, or combination of the two. In the HDR-CDMA system, the process described below is preferably performed once at each slot while the AT is in an access state, i.e., while the AT is communicating with an access network (AN).

An AT, such as AT 101, starts the routine in step 200, and measures downlink signal strength for each sector in an active pilot set in step 201. The AT also measures downlink signal strength for a current serving sector. Thereafter, the AT updates selector selection parameters for each sector in step 202. The update is achieved using timing and hysteresis of a signal level for each sector in the active set. A description thereof will be made in greater detail below. The AT selects a best serving sector based on the selected parameter values for each sector in step 203. If there are one or more serving sector candidates, the AT uses comparative parameters to identify the best serving sector. The use of the comparative parameters will be described in greater detail below. Thereafter, the AT ends the routine in step 204.

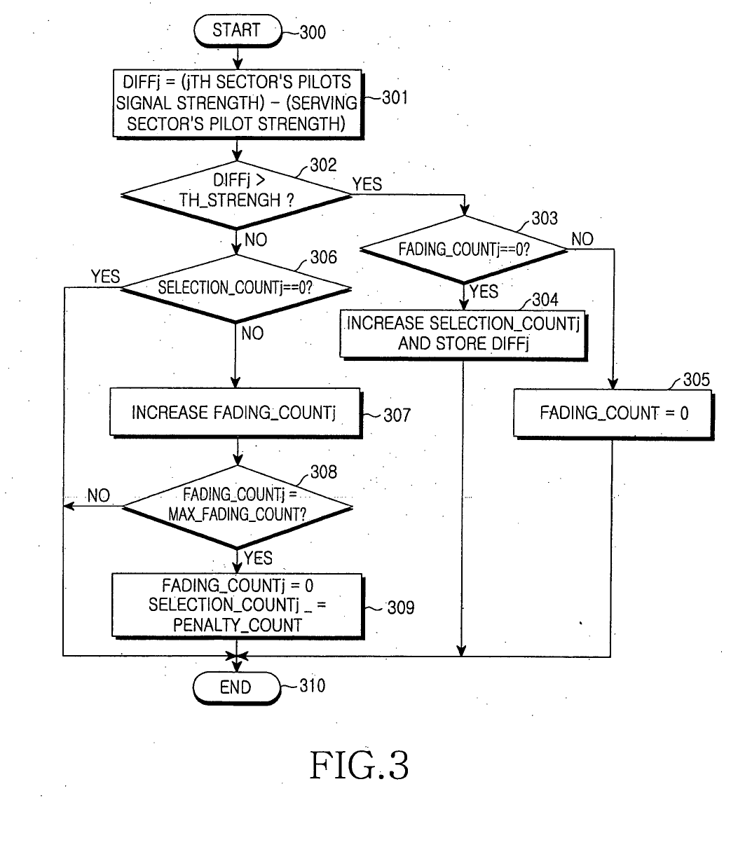

FIG. 3 is a flowchart illustrating a process of updating a selection parameter according to an embodiment of the present invention. With reference to FIG. 3, a detailed description will now be made of a process of updating a selection parameter according to an embodiment of the present invention.

Before a description of FIG. 3 is given, it should be noted that exemplary selection parameters updated using signal strength measured at each slot in an HDR system comprise the following:

(1) DIFF: a parameter that indicates a difference in downlink signal strength between a particular sector in an active set and a current serving sector;

(2) SELECTION_COUNT: a parameter that indicates the number of times the DIFF value was greater than a threshold TH_STRENGTH. This parameter increases when FADING_COUNT described below is 0, and DIFF is greater than TH_STRENGTH. Each time this parameter for a corresponding sector changes from 0 to a non-zero value, i.e., increases, the corresponding sector becomes a serving sector candidate. This parameter is reset after the best serving sector is selected; and

(3) FADING_COUNT: a parameter that indicates the number of times the DIFF value was less than TH_STRENGTH. This parameter increases when the SELECTION_COUNT value is not 0 and the DIFF value is less than the TH_STRENGTH value. This parameter is also reset after the best serving sector is selected.

A description will now be made of a process of updating selection parameters used for searching for a best serving sector based on the foregoing parameters.

An AT, such as AT 101, starts a process of updating selection parameters used for searching for a best serving sector in step 300. The AT calculates a difference in downlink signal strength between a sector in an active set and a current serving sector in step 301. That is, the AT calculates a DIFF value for a j^{th} active sector. Thereafter, the AT determines in step 302 whether the DIFF value for the j^{th} sector is greater than a threshold TH_STRENGTH. If it is determined that the DIFF value is greater than the TH_STRENGTH value, the AT proceeds to step 303. Otherwise, the AT proceeds to step 306.

In step 303, the AT determines whether a FADING_COUNT value for the sector is 0. If the FADING_COUNT value is 0, the AT proceeds to step 304. Otherwise, the AT proceeds to step 305. In step 304, the AT increases a SELECTION_COUNT value for the corresponding sector, stores the DIFF value for the sector, and then proceeds to step 310 where it ends the process. However, in step 305, the AT resets the FADING_COUNT value for the sector to 0, and then proceeds to step 310 where it ends the process.

In step 306, the AT determines whether the SELECTION_COUNT value is 0. If it is determined in step 306 that the SELECTION_COUNT value is 0, the AT proceeds to step 310 where it ends the process.

However, if it is determined in step 306 that the SELECTION_COUNT value is not 0, the AT increases the FADING_COUNT value for the corresponding sector in step 307. Thereafter, the AT determines in step 308 whether the FADING_COUNT value is equal to a MAX_FADING_COUNT value. If it is determined that the FADING_COUNT value is equal to a MAX_FADING_COUNT value, the AT proceeds to step 309. Otherwise, the AT ends the process in step 310. In step 309, the AT resets the FADING_COUNT value for the sector, decreases the SELECTION_COUNT value for the sector by a PENALTY_COUNT value, and then proceeds to step 310 where it ends the process.

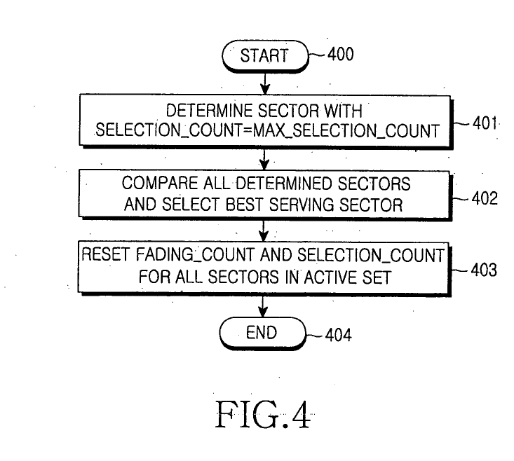

The process of updating the selection parameters, performed in step 202 of FIG. 2, has been described so far with reference to FIG. 3. Next, with reference to FIG. 4, a description will be made of the process of selecting a best serving sector, performed in step 203 of FIG. 2.

FIG. 4 is a flowchart illustrating a process of selecting a best serving sector by an AT according to an embodiment of the present invention. With reference to FIG. 4, a detailed description will now be made of a process of selecting a best serving sector according to an embodiment of the present invention. Before a description of FIG. 4 is given, it should be noted that the process described in FIG. 4 is preferably performed at every HDR slot to identify a best serving sector.

An AT, such as AT 101, starts the process in step 400, and determines (or marks) sectors whose SELECTION_COUNT value is equal to a MAX_SELECTION_COUNT value in step 401. That is, the AT selects a best serving sector from the determined sectors. After step 401, the AT uses comparative parameters to select the best serving sector from the determined sectors in step 402. An exemplary comparative parameter used for selecting the best serving sector from the determined sector comprises the following:

DRC Lock bit information: a parameter that comprises information that is used only in the 1xEV-DO system. This bit is received from all sectors in the active set, and represents reliability of uplink. If a DRC Lock bit received from the sector determined in step 401 is 0, i.e., if the uplink is not reliable, the AT excludes (un-marks) the corresponding sector from the active set.

Herein, the AT calculates a weighted average of pilot signal strength for each of the determined sectors in the active set. The AT selects a sector having the maximum weighted average as a best serving sector. The weighed average of the pilot signal strength is calculated by the following Equation (1),

$$\frac{{\sum }_{i = 1}^{MAX\_SELECTION \_COUNT} {W}_{i} \cdot {DIFF}_{i}}{{\sum }_{i = 1}^{MAX\_SELECTION \_COUNT} {W}_{i}} \qquad ( 1 )$$

wherein Wᵢ denotes a weight assigned to an i^{th} DIFF value and equals a i/MAX_SELECTION_COUNT, and DIFFᵢ denotes an i^{th} DIFF value.

After identifying the best serving sector, the AT resets the FADING_COUNT and SELECTION_COUNT values for all sectors in the active set in step 403, and then ends the process in step 404.

A description will now be made of an apparatus for selecting a serving sector according to an embodiment of the present invention.

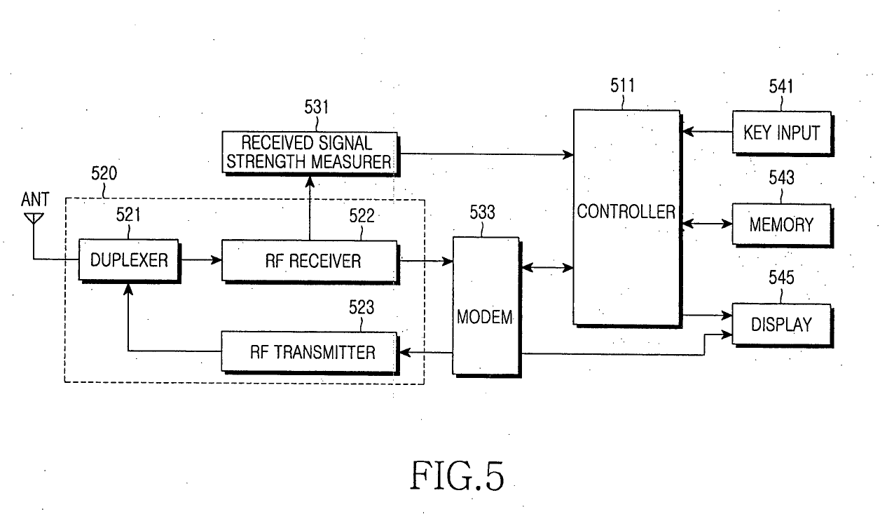

FIG. 5 is a block diagram illustrating an exemplary internal structure of an AT according to an embodiment of the present invention.

Referring to FIG. 5, the exemplary internal structure of an AT comprises a controller 511, a radio frequency (RF) unit 520, a received signal strength measurer 531, a modem 533, a key input 541, a memory 543, and a display 545. The radio frequency (RF) unit 520 of the AT comprises a duplexer 521, an RF receiver 522, and an RF transmitter 523. The duplexer 521 separates a path for a transmission signal from a path for a reception signal. That is, the duplexer 521 outputs a signal received from an antenna ANT to the RF receiver 522, and outputs a signal received from the RF transmitter 523 to the antenna ANT. The RF receiver 522 down-converts a received RF signal into a baseband signal, and outputs the baseband signal to the modem 533. Further, the RF receiver 522 outputs a part of the received signal to the received signal strength measurer 531. The received signal strength measurer 531 measures the strength of a pilot signal received from each sector or cell, and outputs the measured signal strength to the controller 511. The RF transmitter 523 up-converts a baseband transmission signal received from the modem 533 into an RF signal, and outputs the RF signal to the duplexer 521.

The modem 533 performs demodulation and decoding on its input signals, and outputs the result signals to the controller 511 and/or the display 545. Further, the modem 533 encodes and modulates transmission data or a cell selection signal, and outputs the results to the RF transmitter 523. That is, the modem 533 performs modulation/demodulation and coding/decoding operations. The modem 533 can be implemented with a single chip, or implemented with two or more different modem chips for image data processing.

The controller 511 mainly controls the RF unit 520 and the modem 533, and performs a control operation of storing specific control data in the memory 543 or reading data from the memory 543, and processing a corresponding operation. That is, the controller 511 performs the control operations described with reference to FIGS. 2 through 4. Specifically, the controller 511 performs a control operation of selecting the best serving sector using signal strength information received from the received signal strength measurer 531 and parameters stored in the memory 543. The controller 511 also performs other control operations of the AT.

The key input unit 541 generates a signal for a key input by a user and provides the key signal to the controller 511. The key input unit 541 can be implemented with a key matrix, a touch screen, or a voice input device for mapping voice input signals to associated commands. The memory 543 stores the parameters defined above in an embodiment of the present invention, stores control data for the AT and various user data, and temporarily stores control data generated during a control operation of the controller 511. The display 545 can be generally implemented with a liquid crystal display (LCD). Alternatively, the display 545 can be implemented with light emitting diodes.

As can be understood from the foregoing description, embodiments of the present invention can select a correct serving sector and thus prevent unnecessary network switching, thereby guaranteeing stable data transmission. In addition, embodiments of the present invention prevent frequent switching of the serving sector and increase throughput of the network.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for determining a serving sector using a signal received from a base station, the method comprising the steps of:
measuring strength of a pilot signal received from a sector in an active set;
calculating a difference between the measured strength of the signal received from the sector in the active set and strength of a signal received from the serving sector;
comparing the calculated difference with a predetermined threshold and updating selection parameters according to the comparison result; and
selecting a best serving sector from active sectors in the active set using the updated selection parameters and comparative parameters.

2. The method of claim 1, wherein the selection parameters comprise a first parameter for counting the number of times that the difference is greater than the threshold, and a second parameter for counting the number of times that the difference is less than the threshold.

3. The method of claim 1, wherein the comparative parameter comprises a value determined based on reliability of an uplink signal.

4. The method of claim 1, wherein the step of selecting a best serving sector comprises the step of:
selecting a sector having a maximum value of a weighted average of signal strength as calculated by the following equation,
$$\frac{{\sum }_{i = 1}^{MAX\_SELECTION \_COUNT} {W}_{i} \cdot {DIFF}_{i}}{{\sum }_{i = 1}^{MAX\_SELECTION \_COUNT} {W}_{i}}$$
wherein Wᵢ denotes a weight assigned to an i^{th} DIFF value and equals an i/MAX_SELECTION_COUNT, and DIFFᵢ denotes an i^{th} DIFF value and represents a difference between signal strength for the serving sector and signal strength for an i^{th} sector.

5. An apparatus for determining a serving sector using a signal received from a base station, the apparatus comprising:
a received signal strength measurer for measuring strength of a pilot signal received from the serving sector and strength of a pilot signal received from a sector in an active set; and
a controller for calculating a difference between the strength of the pilot signal received from the serving sector and the strength of the pilot signal received from the sector in the active set, updating selection parameters by comparing the calculated difference with a predetermined threshold, and selecting a best serving sector from active sectors in the active set using the updated selection parameters and comparative parameters.

6. The apparatus of claim 5, further comprising a memory for storing the parameters.

7. The apparatus of claim 5, wherein the selection parameters comprise a first parameter for counting the number of times that the difference is greater than the threshold, and a second parameter for counting the number of times that the difference is less than the threshold.

8. The apparatus of claim 5, wherein the comparative parameter comprises a value determined based on reliability of an uplink signal.

9. The apparatus of claim 5, wherein the controller selects, as the best serving sector, a sector having a maximum value of a weighted average of signal strength as calculated by the following equation,
$$\frac{{\sum }_{i = 1}^{MAX\_SELECTION \_COUNT} {W}_{i} \cdot {DIFF}_{i}}{{\sum }_{i = 1}^{MAX\_SELECTION \_COUNT} {W}_{i}}$$
wherein Wᵢ denotes a weight assigned to an i^{th} DIFF value and equals an i/MAX_SELECTION_COUNT, and DIFFᵢ denotes an ith DIFF value and represents a difference between signal strength for the serving sector and signal strength for an i^{th} sector.

10. A computer program embodied on a computer-readable medium for determining a serving sector using a signal received from a base station, comprising:
a first set of instructions for controlling a received signal strength measurer for measuring strength of a pilot signal received from a sector in an active set;
a second set of instructions for controlling a controller for calculating a difference between the measured strength of the signal received from the sector in the active set and strength of a signal received from the serving sector;
a third set of instructions for controlling the controller for comparing the calculated difference with a predetermined threshold and updating selection parameters according to the comparison result; and
a fourth set of instructions for controlling the controller for selecting a best serving sector, from active sectors in the active set using the updated selection parameters and comparative parameters.

11. The computer program embodied on a computer-readable medium of claim 10, wherein the selection parameters comprise a first parameter for counting the number of times that the difference is greater than the threshold, and a second parameter for counting the number of times that the difference is less than the threshold.

12. The computer program embodied on a computer-readable medium of claim 10, wherein the comparative parameter comprises a value determined based on reliability of an uplink signal.

13. The computer program embodied on a computer-readable medium of claim 10, wherein the fourth set of instruction for selecting a best serving sector comprises:
a set of instructions for selecting a sector having a maximum value of a weighted average of signal strength as calculated by the following equation,
$$\frac{{\sum }_{i = 1}^{MAX\_SELECTION \_COUNT} {W}_{i} \cdot {DIFF}_{i}}{{\sum }_{i = 1}^{MAX\_SELECTION \_COUNT} {W}_{i}}$$
wherein Wᵢ denotes a weight assigned to an i^{th} DIFF value and equals an i/MAX_SELECTION_COUNT, and DIFFᵢ denotes an i^{th} DIFF value and represents a difference between signal strength for the serving sector and signal strength for an i^{th} sector.
